(19) United States
(12) Patent Application Publication
(10) Pub. No.: US 2008/0069114 A1
(43) Pub. Date: Mar. 20, 2008

(54) Communication device and method

(75) Inventor: Katsumi Shimada, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/889,439

(22) Filed: Aug. 13, 2007

(30) Foreign Application Priority Data
Sep. 20, 2006 (JP) 2006-254619

(51) Int. Cl. H04L 12/56

(52) U.S. Cl. 370/395.31

(57) ABSTRACT

A communication device and method for restraining frames from being discarded when the number of physical links constituting a communication path has changed while at the same time keeping the traffic amounts of the individual physical links as even as possible. A table memory stores an allocation table showing the correlation between addresses included in incoming frames and the physical links via which the incoming frames are to be output. On detecting a fault of a physical link, a setting controller manipulates the allocation table to divide the range of addresses allocated to the faulty physical link into multiple sections to be reallocated among normal physical links. When a frame is received, a switch looks up the allocation table and determines, in accordance with the address included in the received frame, which of the normal physical links is to be used to output the received frame.

### CROSS-REFERENCE TO RELATED APPLICATIONS

This application is based upon and claims the benefits of priority from the prior Japanese Patent Application No. 2006-254619 filed on Sep. 20, 2006, the entire contents of which are incorporated herein by reference.

### BACKGROUND OF THE INVENTION

1. Field of the Invention

The present invention relates to communication devices and methods for transferring frames, and more particularly, to a communication device and method for transferring frames by using a logical link constituted by an aggregation of physical links.

2. Description of the Related Art

When data is transmitted to a destination terminal device over a network, the transmit data is segmented into frames at the level of the Data-link layer and relayed by communication devices to the destination. The communication devices for relaying frames are, for example, Layer 2 switches. As a method for improving the quality of the communication path between communication devices, link aggregation is known. The link aggregation is a technique whereby a plurality of physical links interconnecting identical types of communication devices, such as cables, are aggregated into a single virtual logical link. With the link aggregation, high-speed communication path can be realized without using expensive cables or communication interfaces. Also, since multiple physical links are simultaneously used, the communication path is prevented from being completely disconnected even if part of the physical links fail, thus enhancing usability. There has also been known a technique wherein, in case of a fault in a physical link constituting the logical link, the faulty physical link is automatically switched to a spare physical link to allow the operation to go on (see, e.g., Unexamined Japanese Patent Publication No. 2004-349764).

When transferring frames by means of the link aggregation function, it is generally required that frames sequentially transmitted from the same source to the same destination should arrive at the destination in the same order. For example, in the case of the specifications for Ethernet (registered trademark), IEEE 802.3 stipulates that the transfer order of frames should be maintained. It is often the case, however, that there is a difference in traffic amount between physical links, and thus, if frames with the same source and the same destination are output via different physical links, it is possible that the order of the frames will be reversed before the frames reach the next communication device. Accordingly, frames need to be controlled so that the frames with the same source and the same destination may always be forwarded via the same physical link. Further, to prevent lowering in the communication efficiency of the logical link, frames also need to be controlled so as not to concentrate at a certain physical link.

A communication device has therefore been proposed which holds, as a table, the correlation between the addresses included in frames and the physical links and which allocates frames to their respective physical links in accordance with the addresses. A frame includes, as the addresses, information identifying a frame-originating terminal device (or a group to which the source terminal device belongs) as well as a destination terminal device (or a group to which the destination terminal device belongs). Such addresses include source/destination MAC addresses, source/destination IP (Internet Protocol) addresses, VLAN (Virtual Local Area Network) tags, etc. To correlate addresses with physical links, hash values calculated from the addresses, for example, may be correlated in one-to-one correspondence with the port numbers of communication ports to which the respective physical links are connected. The link aggregation with such function enables maintenance of the arrival order of frames as well as distribution of the traffic, making it possible to realize high-quality communication paths.

Meanwhile, the number of physical links forming a logical link occasionally changes during the operation of the logical link. Such a situation arises, for example, when a physical link fails but there is no spare physical link, with the result that the logical link is operated thereafter using only the remaining normal physical links. If this occurs in the conventional communication device, the transfer of all frames needs to be temporarily suspended and frames have to be discarded, for the reason stated below.

If a physical link fails, the correlation between the addresses included in frames and the physical links needs to be modified. In this case, it is not desirable that all addresses allocated until then to the faulty physical link be reallocated to another physical link, because the amount of traffic should preferably be distributed equally among the physical links forming the logical link. Thus, in the conventional communication device, when the number of physical links changes, the correlation between the addresses and the physical links is calculated all over again. In the method using hash values to correlate addresses with physical links, for example, if the number of physical links decreases from four to three, the divisor used in the hash function is changed from “4” to “3”. This allows the hash values, which had been distributed equally among “0”, “1”, “2” and “3” before the occurrence of the fault, to be distributed equally among “0”, “1” and “2”.

With this method, however, even the addresses allocated to normal physical links are reallocated to different physical links. Where the divisor is changed, for example, the correlation table may possibly be updated such that the address allocated to physical link 1 (hash value “0”) until then is reallocated to physical link 2 (hash value “1”). If a frame is output to the newly allocated physical link immediately after the table is updated, it is possible that this frame and that output before the updating of the table will be reversed in order.

Accordingly, in order to maintain the arrival order of frames, it is necessary that the transfer of all frames should be suspended until it is ascertained that the frame output immediately before the updating of the table has arrived at the other end of the physical link. This problem arises due to the recalculation of the correlation between all addresses and the physical links.

### SUMMARY OF THE INVENTION

The present invention was created in view of the above circumstances, and an object thereof is to provide a communication device and method capable of restraining frames from being discarded when the number of physical links changes while at the same time keeping the traffic amounts of the individual physical links as even as possible.

To achieve the object, there is provided a communication device for transferring frames by using a logical link constituted by an aggregation of physical links. The communication device comprises a table memory storing an allocation table showing a correlation between addresses included in incoming frames and the physical links via which the incoming frames are to be output, a setting controller, responsive to detection of a fault in any of the physical links, for manipulating the allocation table to divide a range of the addresses allocated to the faulty physical link into multiple sections to be reallocated among normal ones of the physical links, and a switch, responsive to reception of a frame, for looking up the allocation table and determining, in accordance with the address included in the received frame, which of the normal physical links is to be used to output the received frame.

Also, to achieve the above object, there is provided a communication method for transferring frames by using a logical link constituted by an aggregation of physical links. The communication method comprises the step, executed by a setting controller on detection of a fault in any of the physical links, for manipulating an allocation table showing a correlation between addresses included in incoming frames and the physical links via which the incoming frames are to be output, to divide a range of the addresses allocated to the faulty physical link into multiple sections to be reallocated among normal ones of the physical links, and the step, executed by a switch on reception of a frame, for looking up the allocation table and determining, in accordance with the address included in the received frame, which of the normal physical links is to be used to output the received frame.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 schematically illustrates the present invention.

FIG. 2 shows an entire configuration of a frame transfer system.

FIG. 3 shows connections of physical links between switches.

FIG. 4 is a block diagram illustrating the function of the switch.

FIG. 5 shows an exemplary data structure of a frame.

FIG. 6 shows an exemplary data structure of a trunk number table.

FIG. 7 shows an exemplary data structure of a learning table.

FIG. 8 shows an exemplary data structure of a trunk configuration control table.

FIG. 9 shows an exemplary data structure of a port allocation table according to a first embodiment.

FIG. 10 is a flowchart illustrating a frame transfer process.

FIG. 11 is a flowchart illustrating a port allocation process executed in case of fault according to the first embodiment.

FIG. 12 shows an example of updating of the trunk configuration control table.

FIG. 13 shows a first example of updating of the port allocation table of the first embodiment.

FIG. 14 shows a second example of updating of the port allocation table of the first embodiment.

FIG. 15 is a flowchart illustrating a transfer port decision process according to the first embodiment.

FIG. 16 is a flowchart illustrating a port allocation process executed at the time of restoration in the first embodiment.

FIG. 17 is a flowchart illustrating another port allocation process executed at the time of restoration in the first embodiment.

FIG. 18 shows another exemplary data structure of the port allocation table of the first embodiment.

FIG. 19 shows an exemplary data structure of a port allocation table according to a second embodiment.

FIG. 20 is a flowchart illustrating a port allocation process executed in case of fault according to the second embodiment.

FIG. 21 shows an example of updating of the port allocation table of the second embodiment.

FIG. 22 is a flowchart illustrating a transfer port decision process according to the second embodiment.

FIG. 23 is a flowchart illustrating a port allocation process executed at the time of restoration in the second embodiment.

FIG. 24 is a flowchart illustrating another port allocation process executed at the time of restoration in the second embodiment.

FIG. 25 is a flowchart illustrating a link exchange process.

FIG. 26 shows an example of how the port allocation table is updated as a result of link exchange.

### DESCRIPTION OF THE PREFERRED EMBODIMENTS

Preferred embodiments of the present invention will be described below with reference to the accompanying drawings, wherein like reference numerals refer to like elements throughout. First, a general idea of the present invention will be explained, followed by detailed description of specific embodiments.

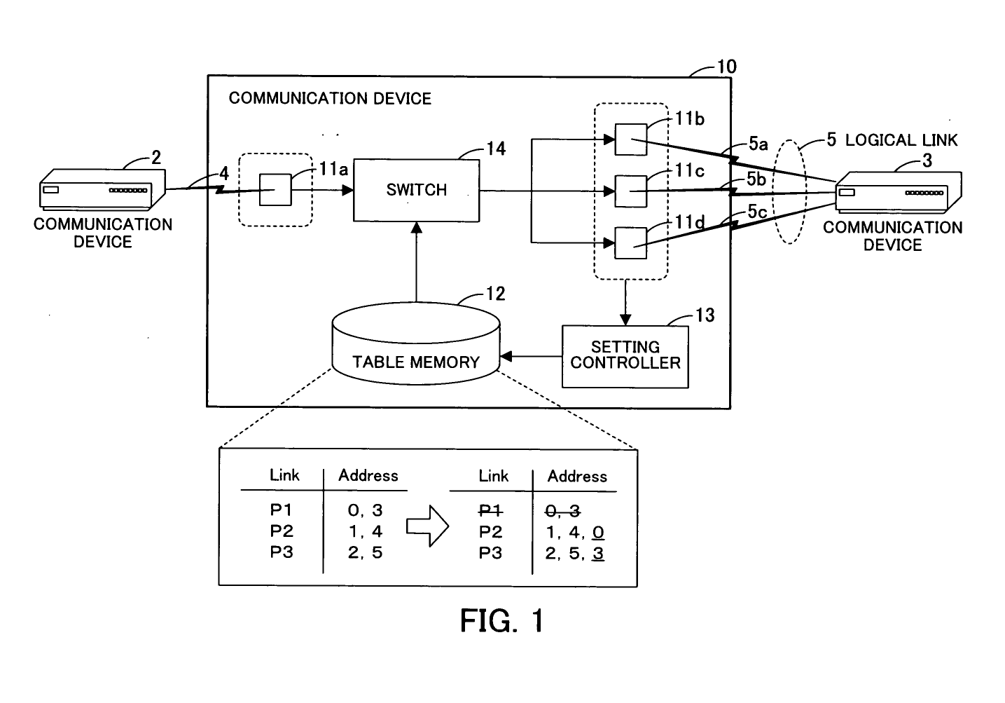

FIG. 1 schematically illustrates the present invention. As shown in FIG. 1, a communication device 10 according to the present invention transfers frames by using a logical link 5 constituted by an aggregation of physical links 5a, 5b and 5c.

The communication device 10 includes communication ports 11a, 11b, 11c and 11d, a table memory 12, a setting controller 13, and a switch 14. The communication port 11a is connected to a communication device 2 by a physical link 4. The communication ports 11b, 11c and 11d are connected to a communication device 3 by the physical links 5a, 5b and 5c, respectively. Namely, the communication devices 10 and 3 are interconnected by the three physical links 5a, 5b and 5c. The physical links 5a, 5b and 5c are aggregated to constitute the single logical link 5.

The table memory 12 stores an allocation table. The allocation table defines the manner of how frames received from the communication device 2 should be allocated to the three physical links 5a, 5b and 5c. Specifically, the allocation table holds the correlation between the addresses included in frames and the physical links 5a, 5b and 5c via which the frames are to be output.

The setting controller 13 monitors the status of communication of the communication ports 11b, 11c and 11d to detect a fault. On detecting a fault in the physical link 5a, for example, the setting controller 13 manipulates the allocation table stored in the table memory 12, to modify the correlation between the addresses and the physical links 5a, 5b and 5c. Specifically, the range of the addresses allocated to the faulty physical link 5a is divided into multiple sections to be reallocated to the normal physical links 5b and 5c.

For example, suppose the case where addresses 0 and 3 are allocated to the physical link 5a (identification number: P1), addresses 1 and 4 are allocated to the physical link 5b (identification number: P2), and addresses 2 and 5 are allocated to the physical link 5c (identification number: P3). In this case, if a fault occurs in the physical link 5a, the setting controller 13 reallocates the addresses 0 and 3, which have been allocated to the faulty physical link 5a, to the normal physical links 5b and 5c. For example, the address 0 is reallocated to the physical link 5b, and the address 3 to the physical link 5c.

When a frame is received from the communication device 2, the switch 14 extracts address information from the received frame. Then, the switch 14 looks up the allocation table to determine a normal physical link via which the frame is to be output. Where the received frame includes the address 0, for example, the physical link 5b is judged to be the output link.

In the communication device 10 described above, the table memory 12 stores the allocation table showing the correlation between the addresses included in frames and the physical links 5a, 5b and 5c via which the frames are to be output. On detecting a fault of, for example, the physical link 5a, the setting controller 13 manipulates the allocation table such that the range of the addresses which have been allocated to the faulty physical link 5a is reallocated to the normal physical links 5b and 5c. Frames received thereafter are output to the normal physical links determined by the switch 14 in accordance with the allocation table.

Consequently, only the addresses allocated to the faulty physical link 5a are reallocated to the other physical links 5b and 5c, and the addresses allocated to the normal physical links 5b and 5c are not reallocated, permitting the frame transfer to be continued. In the example shown in FIG. 1, the addresses 0 and 3 associated with the physical link 5a are reallocated, but the addresses 1, 2, 4 and 5 associated with the physical links 5b and 5c are not reallocated.

Thus, even if the transfer of frames is restarted immediately after the allocation table is updated, the arrival order of frames is not reversed. Temporary discard of frames, that is required in the conventional devices, can therefore be restrained, making it possible to realize a stable communication path with higher quality.

As a specific method of correlating addresses with the physical links 5a, 5b and 5c, the physical links 5a, 5b and 5c may be correlated in one-to-many correspondence with hash values calculated from the addresses, for example. The hash value is calculated from an address by using a hash function that can assume a number greater than the number of the physical links 5a, 5b and 5c constituting the logical link 5.

This method simplifies the process of identifying physical links from addresses and also facilitates the division of an address range and the reallocation of addresses to other physical links.

Also, to correlate addresses with the physical links 5a, 5b and 5c, another method may be employed in which first hash values calculated from the addresses are correlated in one-to-one correspondence with the physical links 5a, 5b and 5c and second hash values calculated from the addresses are correlated with normal physical links, for example. The switch 14 first calculates the first hash value to identify a physical link allocated in the initial state and, if the identified physical link is faulty, calculates the second hash value to identify a substitute physical link.

With this method, it is possible to reduce the size of memory for storing the allocation table and also to distribute the traffic amount more equally among normal physical links.

Embodiments of the present invention will be now described in detail with reference to the drawings.

### First Embodiment

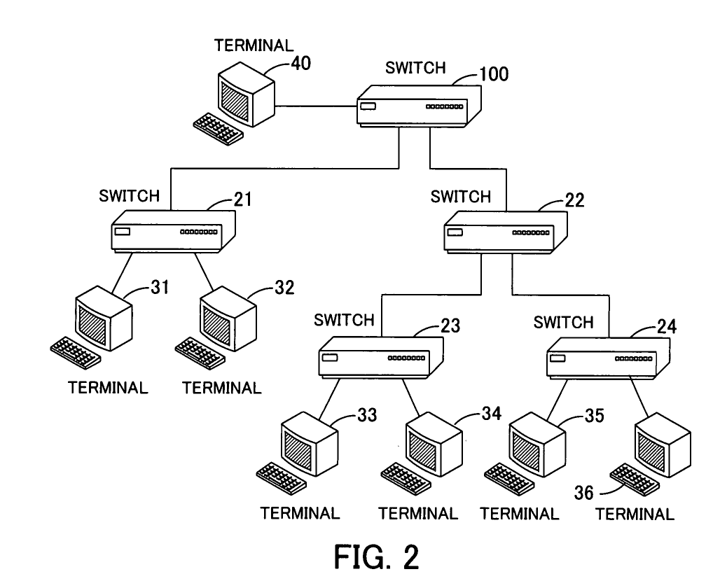

FIG. 2 shows an entire configuration of a frame transfer system. In the frame transfer system of this embodiment, a plurality of Layer 2 switches relay frames at the Data-link layer to allow exchange of data among terminal devices.

The frame transfer system shown in FIG. 2 comprises switches 100, 21, 22, 23 and 24, and terminals 31, 32, 33, 34, 35, 36 and 40. The switches 100 and 21 to 24 are Layer 2 switches, and the terminals 31 to 36 are terminal devices operated by users. The terminal 40 is a terminal device used by an administrator who administers the switch 100.

The switch 100 is connected with the switches 21 and 22, and the switch 22 is connected with the switches 23 and 24. The terminals 31 and 32 are connected to the switch 21, the terminals 33 and 34 are connected to the switch 23, and the terminals 35 and 36 are connected to the switch 24. The terminal 40 is connected to the switch 100. One or more physical links (network cables) are used to interconnect two switches associated with each other or a switch and a terminal associated therewith.

The switches 100 and 21 to 24 relay frames from a source terminal to a destination terminal in accordance with the addresses included in the frames. Where the terminal 31 sends a frame to the terminal 33, for example, the frame is relayed successively by the switches 21, 100, 22 and 23.

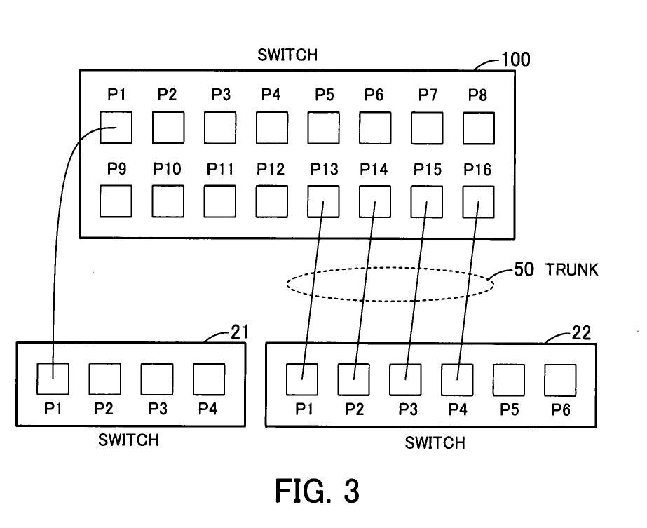

FIG. 3 shows the configuration of physical links between the switches 100 and 21 and between the switches 100 and 22. The switch 100 has 16 communication ports P1 to P16, the switch 21 has four communication ports P1 to P4, and the switch 22 has six communication ports P1 to P6.

The switches 21 and 100 are interconnected by a single physical link. Specifically, the communication port P1 of the switch 21 and the communication port P1 of the switch 100 are connected by a physical link. Accordingly, frames from the switch 21 to the switch 100 are transferred via the communication ports P1 of the switches 21 and 100.

The switches 22 and 100 are connected to each other by four physical links. Specifically, the communication port P1 of the switch 22 and the communication port P13 of the switch 100 are connected by a physical link. Similarly, the communication ports P2, P3 and P4 of the switch 22 are respectively connected to the communication ports P14, P15 and P16 of the switch 100, each by a physical link.

The four physical links between the switches 22 and 100 are aggregated to constitute a single logical link. In the following description, a logical link formed by link aggregation is called trunk. Namely, the four physical links between the switches 22 and 100 constitute a trunk 50.

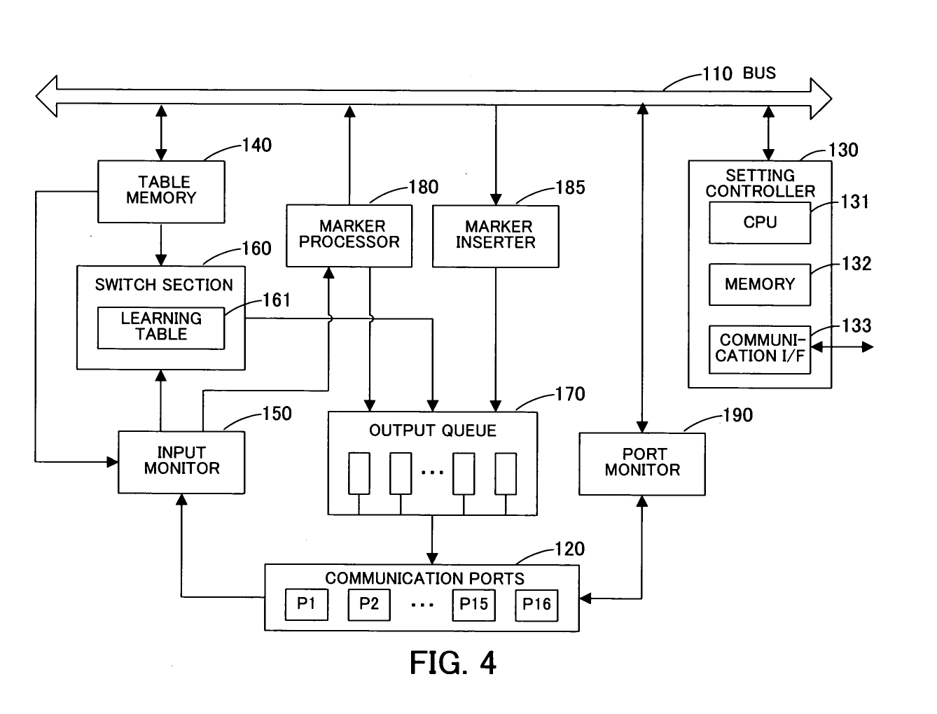

FIG. 4 is a block diagram illustrating the function of the switch. More specifically, FIG. 4 shows the internal configuration of the switch 100, and the other switches 21 to 24 may be configured in like manner. The switch 100 includes a bus 110, a communication port group 120, a setting controller 130, a table memory 140, an input monitor 150, a switch section 160, an output queue 170, a marker processor 180, a marker inserter 185, and a port monitor 190.

The setting controller 130, the table memory 140, the marker processor 180 and the marker inserter 185 are connected to the bus 110. The communication port group 120 includes 16 communication ports P1 to P16, to each of which a physical link can be connected.

The setting controller 130 globally controls the switch 100 and includes a CPU (Central Processing Unit) 131, a memory 132, and a communication interface 133. The CPU 131 executes process in accordance with programs, and the memory 132 stores the programs executed by the CPU 131 as well as data used by the programs. The communication interface 133 receives commands from the terminal 40 used by the administrator and supplies the commands to the CPU 131. Also, the communication interface sends the results of execution of commands to the terminal 40 as a response.

The table memory 140 stores a plurality of tables including a table for managing the trunk configuration and a table showing the method for allocation of frames in the trunk.

The input monitor 150 monitors the communication port group 120 and acquires incoming frames therefrom. The input monitor 150 includes a buffer for temporarily holding a plurality of frames in case multiple frames arrive at the communication port group at the same time.

The input monitor 150 sends the acquired frame to the switch section 160 if the frame is an ordinary frame, and sends the acquired frame to the marker processor 180 if the frame is a marker request or a marker response. The marker request is a special frame demarcating a sequence of frames, and the marker response is a special frame which, on reception of a marker request, the communication device sends back to the source of the marker request.

The switch section 160 includes a learning table 161. The learning table 161 stores the source addresses of frames received in the past, in association with the information identifying the communication ports or trunks via which the respective frames were received. The learning table 161 is updated by the switch section 160 whenever necessary.

When a frame is received from the input monitor 150, the switch section 160 looks up the learning table 161 and determines the target to which the frame is to be forwarded. If the determined target is a trunk, the switch section 160 looks up tables stored in the table memory 140 to determine a specific communication port to which the frame is to be forwarded. Then, the switch section 160 sends the frame to the output queue 170.

The output queue 170 has FIFO (First In First Out) queues associated with the respective communication ports, that is, 16 FIFO queues corresponding to the communication ports P1 to P16, respectively. The output queue 170 stores frames, received from the switch section 160, the marker processor 180 and the marker inserter 185, in the FIFO queues associated with their respective output communication ports. Also, the output queue 170 monitors the communication port group 120 and successively reads out the frames from the FIFO queues at proper timing to send out the frames to their corresponding communication ports.

The marker processor 180 sends a marker response, which is responsive to the marker request received from the input monitor 150, to the output queue 170. The marker inserter 185 sends a marker request to the output queue 170 in accordance with instructions from the setting controller 130.

The port monitor 190 monitors the communication port group 120. On detecting fault or restoration of any of the physical links connected to the communication ports, the port monitor 190 notifies the setting controller 130 of such fault or restoration.

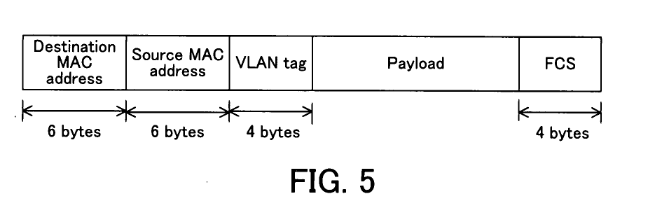

FIG. 5 exemplifies the data structure of a frame, which is exchanged, for example, between the switches 21 and 22 via the communication ports P1 to P16. The frame is made up of a destination MAC address, a source MAC address, a VLAN tag, a payload, and an FCS (Frame Check Sequence).

The destination MAC address is an address uniquely identifying the communication interface of a destination terminal, and the source MAC address is an address uniquely identifying the communication interface of a source terminal. The VLAN tag is used in cases where a network is segmented into a plurality of logical networks, and represents a unique value assigned to each logical network. The payload is the body of transmit/receive data and holds a predetermined length of data obtained, for example, by fragmenting an IP packet. The FCS is a value used to detect error in the received frame.

The data structure of the frame is modifiable in various ways in accordance with the form of operation of the network, etc. For example, the VLAN tag is omitted or other header information than that shown in FIG. 5 is added as the case may be.

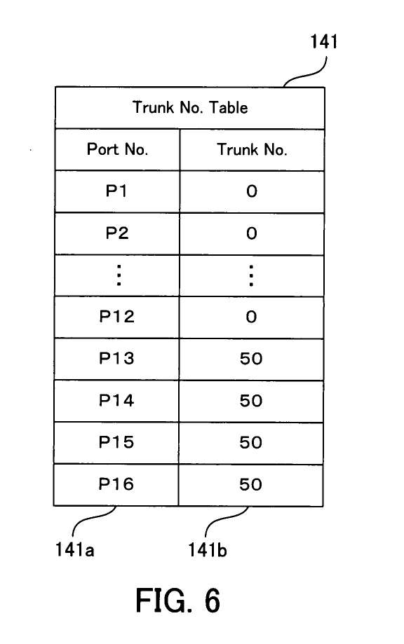

FIG. 6 exemplifies the data structure of a trunk number table. The trunk number table 141 shown in FIG. 6 is stored in the table memory 140 and shows the correlation between the communication ports and trunks. The trunk number table 141 has fields 141a showing port numbers and fields 141b showing trunk numbers. A pair of information items contained in each horizontal row of fields are associated with each other.

A port number uniquely identifying a communication port is set in the field 141a. Specifically, one of the values P1 to P16 is set in the field. The field 141b holds information indicating whether the physical link connected to the communication port specified in the corresponding field 141a constitutes a trunk or not. Specifically, if the physical link constitutes a trunk, a trunk number uniquely identifying the trunk is set, and if the physical link does not constitute a trunk, “0” is set.

The example shown in FIG. 6 indicates that the communication ports P1 to P12 do not belong to any trunk and that the four communication ports P13 to P16 belong to the trunk 50. The information in the trunk number table 141 is registered beforehand by the setting controller 130 in response to the input operation by the administrator.

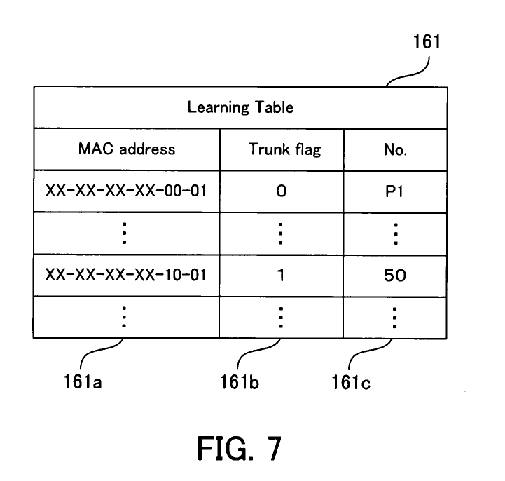

FIG. 7 shows an exemplary data structure of the learning table. The learning table 161 has fields 161a showing MAC addresses, fields 161b showing the states of a trunk flag, and fields 161c showing port numbers or trunk numbers. A set of information items contained in each horizontal row of fields are associated with one another.

The MAC address of a frame is set in the field 161a. The field 161b holds the trunk flag indicating whether the communication port that received the frame having the source MAC address specified in the corresponding field 161a belongs to a trunk or not. Specifically, “0” is set if the communication port does not belong to any trunk, and “1” is set if the communication port belongs to a trunk.

The field 161c holds the port number of the communication port or the trunk number of the trunk via which the frame having the source MAC address specified in the corresponding field 161a was received. Specifically, the port number is set if “0” is set in the field 161b, and the trunk number is set if “1” is set in the field 161b.

The information registered in the learning table 161 is updated by the switch section 160 when necessary. When a frame is received and if the source MAC address contained therein already exists in the learning table 161, the switch section 160 overwrites the values in the corresponding fields 161b and 161c. For example, if the communication port receiving frames with the source MAC address XX-XX-XX-XX-00-01 changes from P1 to P2, the value in the corresponding field 161c is updated from P1 to P2.

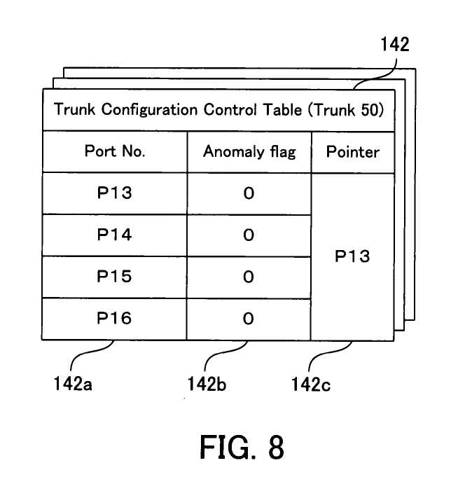

FIG. 8 exemplifies the data structure of a trunk configuration control table. The trunk configuration control table 142 is stored in the table memory 140 in association with each trunk. The trunk configuration control table 142 has fields 142a showing port numbers, fields 142b showing the states of an anomaly flag, and a field 142c showing a pointer. A pair of information items contained in each horizontal row of the fields 142a and 142b are associated with each other.

The port number of a communication port belonging to the trunk is set in the field 142a. The field 142b holds a value indicating the status of the communication port specified in the corresponding field 142a. Specifically, “0” is set if the physical link connected to the communication port is normal, and “1” is set if the physical link is faulty.

The field 142c holds a pointer pointing to one of the port numbers set in the fields 142a. The pointer set in the field 142c is used when a port allocation table, described later, is created and updated. The manner of how the pointer in the field 142c is used will be explained later.

The example shown in FIG. 8 indicates that the four communication ports P13 to P16 belong to the trunk 50 and are all normal. The values in the fields 142a are registered beforehand by the setting controller 130 in response to the input operation by the administrator. The values set in the fields 142b and 142c are updated by the setting controller 130 when necessary.

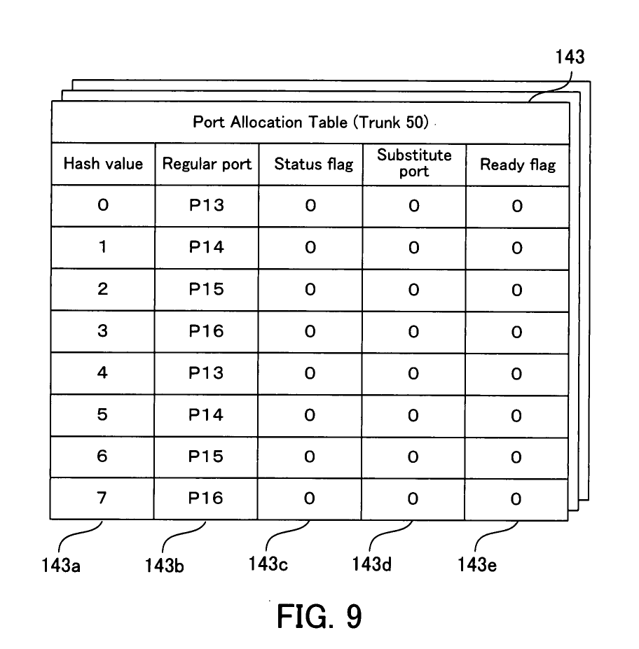

FIG. 9 exemplifies the data structure of a port allocation table according to the first embodiment. The port allocation table 143 is stored in the table memory 140 in association with each trunk, and defines the correlation between MAC addresses and the communication ports for outputting frames.

The port allocation table 143 has fields 143a showing hash values, fields 143b showing regular ports, fields 143c showing the states of a status flag, fields 143d showing substitute ports, and fields 143e showing the states of a ready flag. A set of information items contained in each horizontal row of fields are associated with one another.

A hash value calculated from the MAC address of a frame is set in the field 143a. The number of hash values prepared is greater than the number of communication ports belonging to the trunk. For example, the number of hash values may be twice the number of communication ports (where the number of communication ports is N, integers “0” to “2×N−1” are prepared as the hash values).

The field 143b holds the port number of a corresponding communication port. Specifically, in this field is set the target for outputting the frame from which the hash value specified in the corresponding field 143a is derived. The port numbers are set in the fields 143b so as not to be concentrated at a certain communication port.

The field 143c holds a value indicating the status of the communication port specified in the corresponding field 143b. Specifically, “0” is set if the physical link connected to the communication port is normal, and “1” is set if the physical link is faulty. In the field 143d, “0” is set if the corresponding communication port is normal, and the port number of a substitute communication port is set if the communication port is anomalous.

The field 143e is used when the physical link recovers from fault, and holds a flag indicating a preparatory time upon expiry of which the use of the restored physical link is restarted. Specifically, “0” is set if the current time is not within the preparatory time, and “1” is set if the current time is within the preparatory time. While the value in the field 143e remains at “1”, frames from which the hash value specified in the corresponding field 143a are derived are not forwarded but discarded.

The example shown in FIG. 9 indicates that the eight hash values “0” to “7” are prepared for the four communication ports and that each communication port is correlated with two of the eight hash values. The values in the fields 143a and 143b are registered beforehand by the setting controller 130 in response to the input operation by the administrator. The values set in the fields 143c, 143d and 143e are updated by the setting controller 130 when necessary.

When port numbers are set in the fields 143b, the trunk configuration control table 142 shown in FIG. 8 is looked up. The pointer set in the field 142c points to the port number following the last-selected port number (where the bottom of the table is reached, the port number at the top of the table). The port number P16 is selected last when the port allocation table 143 is created, and therefore, the pointer in the field 142c points to the next port number P13, as shown in FIG. 8.

Processes executed by the system configured as described above will be now described in detail. In the following, explanation will be made of (1) the frame transfer process executed while the physical links forming the trunk 50 are all normal, (2) the manner of how the frame allocation method is changed when one of the physical links in the trunk 50 fails, (3) the frame transfer process executed after the allocation method is changed, and (4) the manner of how the allocation method is changed again when the faulty physical link is restored to normalcy, in the order mentioned.

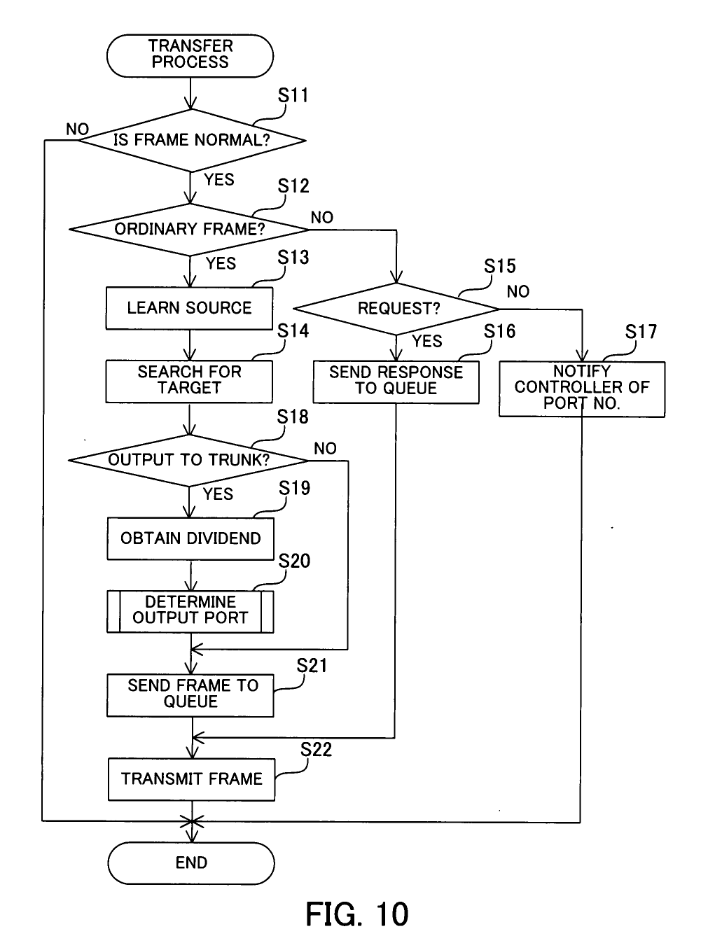

FIG. 10 is a flowchart illustrating the frame transfer process. The process shown in FIG. 10 will be explained below in order of step number.

Step S11: On acquiring a frame from any one of the communication ports in the group 120, the input monitor 150 determines whether or not the acquired frame has a format error. If there is no format error, the process proceeds to Step S12; if the frame has a format error, the input monitor 150 discards the frame, whereupon the frame transfer process ends.

Step S12: The input monitor 150 determines whether the acquired frame is an ordinary frame or not. If the acquired frame is an ordinary frame, the process proceeds to Step S13. If the frame is not an ordinary one, that is, if the frame is a marker request or a marker response, the process proceeds to Step S15. Whether a frame is an ordinary frame or not can be determined by the destination MAC address of the frame. A frame with the destination MAC address 01-80-C2-00-00-02 is either a marker request or a marker response.

Step S13: The input monitor 150 searches the trunk number table 141 stored in the table memory 140, to determine whether or not the communication port via which the frame has been received belongs to a trunk. Then, the input monitor 150 sends, to the switch section 160, the frame and the port number of the communication port or the trunk number of the trunk via which the frame has been received. Using the source MAC address of the received frame and the port number or the trunk number, the switch section 160 updates the learning table 161.

Step S14: The switch section 160 searches the learning table 161 to identify the port number or trunk number corresponding to the destination MAC address of the received frame.

Step S15: The input monitor 150 sends, to the marker processor 180, the frame and the port number of the communication port via which the frame has been received. The marker processor 180 determines whether the received frame is a marker request or not. If the received frame is a marker request, the process proceeds to Step S16. If the received frame is not a marker request, that is, if the frame is a marker response, the process proceeds to Step S17. Whether a frame is a marker request or not can be determined by the TLV_type field in the payload of the frame. Specifically, if the TLV_type field carries the value “01”, the frame is a marker request, and if the TLV_type field carries the value “02”, the frame is a marker response.

Step S16: The marker processor 180 creates a marker response and sends the response to the output queue 170 while specifying the port number notified from the input monitor in Step S15. The output queue 170 stores the received marker response in the FIFO queue corresponding to the specified port number. The process then proceeds to Step S22.

Step S17: The marker processor 180 notifies the setting controller 130 of the port number notified from the input monitor in Step S15, whereupon the frame transfer process ends.

Step S18: The switch section 160 looks up the trunk flag in the learning table 161 to determine whether the output target corresponding to the destination MAC address of the received frame belongs to a trunk or not. If the target belongs to a trunk, the process proceeds to Step S19; if not, the process proceeds to Step S21.

Step S19: The switch section 160 calculates a dividend for deriving a hash value. Specifically, an exclusive-OR of the destination and source MAC addresses of the frame is calculated.

Step S20: The switch section 160 looks up the port allocation table 143 for the trunk number identified in Step S14, and calculates a hash value by using the dividend obtained in Step S19. Specifically, the dividend is divided by the number of hash values prepared in the port allocation table 143, and the remainder obtained is used as the hash value. Subsequently, the switch section 160 searches the port allocation table 143 to identify the port number correlated with the calculated hash value. It is assumed here that all physical links are operating normally, and the process executed when a faulty physical link exists will be explained in detail later.

Step S21: The switch section 160 sends the frame received from the input monitor 150 to the output queue 170 while specifying the port number identified in Step S14 or S20. The output queue 170 stores the received frame in the FIFO queue corresponding to the specified port number.

Step S22: The output queue 170 fetches the frame from the FIFO queue according to the bandwidth of the physical link connected to the communication port, and transmits the frame from the communication port.

In this manner, the input monitor 150 acquires a frame from the communication port group 120 and sends the acquired frame to the switch section 160 or the marker processor 180 in accordance with the frame type. The switch section 160 searches the learning table 161 to identify the communication port or trunk to which the frame is to be output. If the target to which the frame is to be forwarded is a trunk, the switch section searches the corresponding port allocation table 143 by using the MAC addresses, to identify a communication port in the trunk.

If the received frame is a marker request, the marker processor 180 creates a marker response. Where a marker response is received, the marker processor notifies the setting controller 130 of the reception of the marker response. The output queue 170 stores, in the FIFO queues, frames received from the switch section 160 and the marker processor 180, and outputs the frames from the communication ports at proper timing.

The following describes the manner of how the frame allocation method is changed when a physical link in the trunk 50 fails.

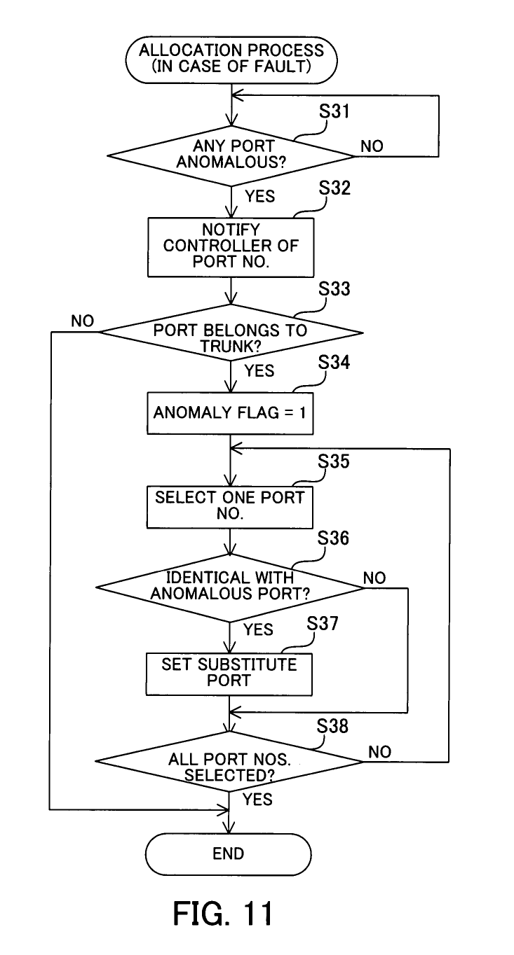

FIG. 11 is a flowchart illustrating a port allocation process executed in case of fault according to the first embodiment. The process shown in FIG. 11 will be explained below in order of step number.

Step S31: The port monitor 190, which continuously monitors the status of the communication ports, determines whether or not there is an anomalous communication port. If there is an anomalous communication port, the process proceeds to Step S32; if there is no anomalous communication port, Step S31 is repeatedly executed by the port monitor 190.

Step S32: The port monitor 190 notifies the setting controller 130 of the port number of the communication port with respect to which anomaly was detected in Step S31.

Step S33: The setting controller 130 searches the trunk number table 141 stored in the table memory 140, to determine whether the communication port with the port number notified from the port monitor 190 belongs to a trunk or not. If the communication port belongs to a trunk, the process proceeds to Step S34; if not, the allocation process ends.

Step S34: The setting controller 130 identifies the trunk number from the trunk number table 141, and selects the trunk configuration control table 142 corresponding to the identified trunk number. Then, the setting controller 130 changes the value of the anomaly flag corresponding to the notified port number, among those in the selected trunk configuration control table 142, to “1”.

Step S35: The setting controller 130 selects the port allocation table 143 corresponding to the trunk number identified in Step S34. Then, the setting controller 130 selects a value (other than “0”) indicative of a port number, from among those set as the regular ports (fields 143b) and the substitute ports (fields 143d) in the selected port allocation table 143.

Step S36: The setting controller 130 determines whether or not the port number selected in Step S35 is identical with the notified port number. If the two port numbers coincide, the process proceeds to Step S37; if not, the process proceeds to Step S38.

Step S37: The setting controller 130 looks up the port number pointed by the pointer in the field 142c of the trunk configuration control table 142 selected in Step S34, to determine whether or not the anomaly flag of the port number is “0” and, if the anomaly flag is not “0”, successively moves the pointer until a port number whose anomaly flag is “0” is found. When a port number of which the anomaly flag is “0” is found, the setting controller acquires this port number and also moves the pointer by one. Then, if the port number selected in Step S35 shows a regular port, the setting controller 130 sets the corresponding status flag to “1” and also sets the acquired port number in the corresponding “Substitute port” field. If the port number selected in Step S35 shows a substitute port, the substitute port number is replaced with the acquired port number.

Step S38: The setting controller 130 determines whether or not all values indicative of port numbers have been selected in Step S35. If all values have been selected, the process ends; if there remains an unselected value or values, the process proceeds to Step S35.

Thus, on detecting a faulty communication port, the port monitor 190 notifies the setting controller 130 of the port number of the detected communication port. The setting controller 130 then manipulates the port allocation table 143 to set a substitute port with respect to the hash value correlated with the detected communication port.

The following describes how the tables are updated when the physical link connected to the communication port P13, for example, fails.

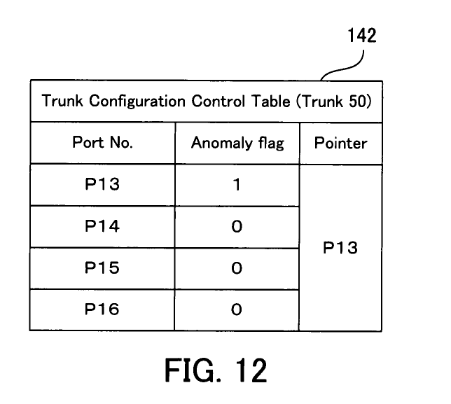

FIG. 12 shows an example of updating of the trunk configuration control table, wherein the trunk configuration control table 142 has been updated from the state shown in FIG. 8 to the state shown in FIG. 12 by the execution of the aforementioned Step S34. As shown in FIG. 12, the anomaly flag associated with the port number P13 has been changed to “1”.

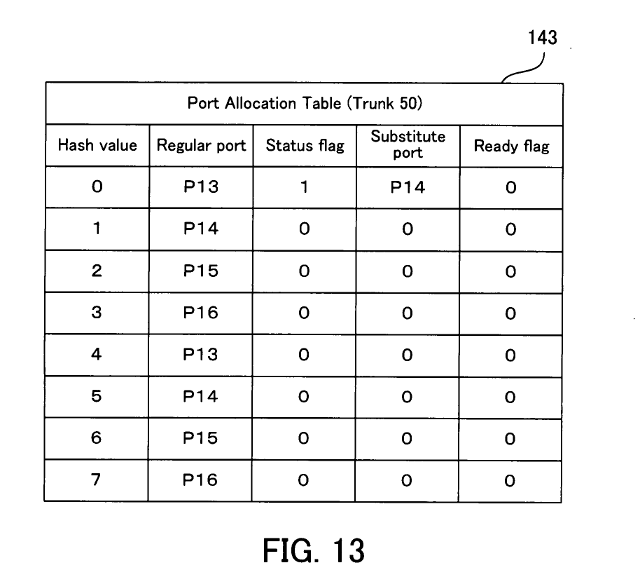

FIG. 13 shows a first example of updating of the port allocation table of the first embodiment, wherein the port allocation table 143 has been updated from the state shown in FIG. 9 to the state shown in FIG. 13 by the first execution of the aforementioned Step S37. As shown in FIG. 13, the status flag associated with the hash value “0” has been set to “1” and the port number P14 has been set as the corresponding substitute port. At this time, the pointer in the trunk configuration control table 142 points to the port number P15.

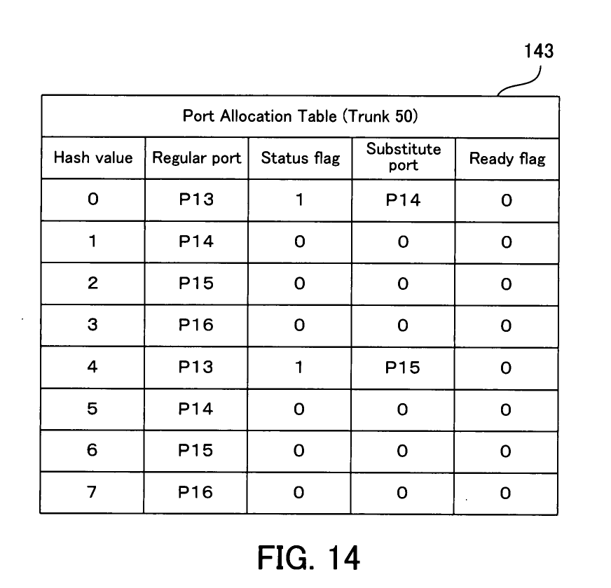

FIG. 14 shows a second example of updating of the port allocation table of the first embodiment, wherein the port allocation table 143 has been further updated from the state shown in FIG. 13 to the state shown in FIG. 14 by the second execution of Step S37. As shown in FIG. 14, the status flag associated with the hash value “4” has been set to “1” and the port number P15 has been set as the corresponding substitute port. At this time, the pointer in the trunk configuration control table 142 points to the port number P16.

The following describes the frame transfer process executed after the allocation method is changed. The frame transfer process executed when there is a faulty physical link in the trunk is in principle identical with that shown in FIG. 10. When determining the output communication port in Step S20, however, the use of the substitute port in lieu of the regular port needs to be taken into account.

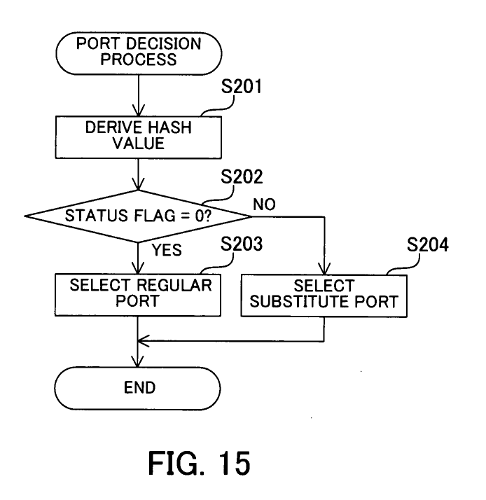

FIG. 15 is a flowchart illustrating a transfer port decision process according to the first embodiment. The flowchart of FIG. 15 shows details of Step S20 in FIG. 10. The process shown in FIG. 15 will be explained below in order of step number.

Step S201: The switch section 160 calculates a hash value for the acquired frame. Specifically, an exclusive-OR of the destination and source MAC addresses of the frame is derived as a dividend, and the dividend is divided by the divisor, which is the number of hash values prepared in the port allocation table 143, to obtain the remainder.

Step S202: The switch section 160 searches the port allocation table 143 to determine whether the status flag associated with the hash value calculated in Step S201 is “0” or not. If the status flag is “0”, the process proceeds to Step S203; if the status flag is “1”, the process proceeds to Step S204.

Step S203: The switch section 160 determines the communication port set in the “Regular port” field, as the target to which the frame is to be output.

Step S204: The switch section 160 determines the communication port set in the “Substitute port” field, as the target to which the frame is to be output.

In this manner, the switch section 160 reallocates only the communication port associated with a faulty physical link to the substitute port and does not reallocate the communication ports associated with normal physical links.

The following describes how the allocation method is changed again when the faulty physical link is restored to normalcy.

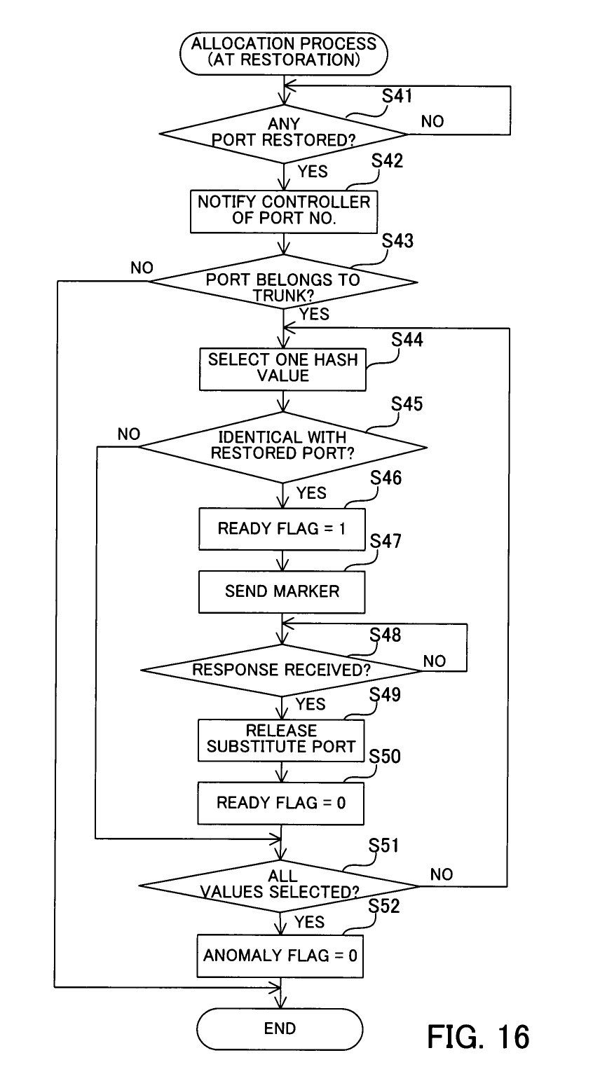

FIG. 16 is a flowchart illustrating a port allocation process executed at the time of restoration in the first embodiment. The process shown in FIG. 16 will be explained below in order of step number.

Step S41: The port monitor 190, which continuously monitors the status of the communication ports, determines whether or not there is a physical link that has been restored to normalcy. If there is a restored physical link, the process proceeds to Step S42; if there is no restored physical link, Step S41 is repeatedly executed by the port monitor 190.

Step S42: The port monitor 190 notifies the setting controller 130 of the port number of the communication port with respect to which the restoration was detected.

Step S43: The setting controller 130 searches the trunk number table 141 stored in the table memory 140, to determine whether the communication port with the port number notified from the port monitor 190 belongs to a trunk or not. If the communication port belongs to a trunk, the process proceeds to Step S44; if not, the allocation process ends.

Step S44: The setting controller 130 selects a hash value from among those set in the port allocation table 143 corresponding to the trunk identified in Step S43.

Step S45: The setting controller 130 determines whether or not the port number of the regular port corresponding to the hash value selected in Step S44 is identical with the detected port number. If the two port numbers coincide, the process proceeds to Step S46; if not, the process proceeds to Step S51.

Step S46: The setting controller 130 sets the ready flag associated with the hash value selected in Step S44 to “1”.

Step S47: The setting controller 130 instructs the marker inserter 185 to output a marker request to the substitute port associated with the hash value selected in Step S44. On receiving the instruction, the marker inserter 185 creates a marker request and sends the request to the output queue 170 while specifying the port number instructed from the setting controller 130.

Step S48: The setting controller 130 determines whether or not a notification informing the reception of a marker response in reply to the marker request sent in Step S47 has been received from the marker processor 180. If such a notification has been received, the process proceeds to Step S49; if not, Step S48 is repeatedly executed until the notification is received.

Step S49: The setting controller 130 resets the “Substitute port” field and status flag associated with the hash value selected in Step S44 to “0”.

Step S50: The setting controller 130 resets the ready flag associated with the hash value selected in Step S44 to “0”.

Step S51: The setting controller 130 determines whether or not all hash values have been selected in Step S44. If all hash values have been selected, the process proceeds to Step S52; if there remains an unselected hash value or values, the process proceeds to Step S44.

Step S52: The setting controller 130 sets “0” for the anomaly flag corresponding to the port number notified in Step S42, among those in the trunk configuration control table 142 corresponding to the trunk identified in Step S43.

Thus, on detecting the restoration of a physical link to normalcy, the port monitor 190 notifies the setting controller 130 of the port number of the communication port connected to the restored physical link. The setting controller 130 then manipulates the port allocation table 143 to cancel the substitute port setting with respect to the notified communication port. In this case, a marker request is output to, the substitute port and the value of the ready flag is kept at “1” until a marker response responsive to the request is received. This procedure is followed so that the transfer order of frames output from the substitute port and the restored regular port may not be reversed.

While the ready flag remains at “1”, the switch section 160 stops outputting frames to the substitute port and discards the frames. Specifically, whether the ready flag is “1” or not is determined in Step S204 of the port decision process shown in FIG. 15, and if the ready flag is “1”, frames are discarded. It should be noted, however, that not all of the frames allocated to the trunk are discarded but only those frames with respect to which “1” is set as the ready flag are discarded.

In the example explained above, a marker request and a marker response are used to prevent the reversal of the transfer order of frames, but a timer may be used instead.

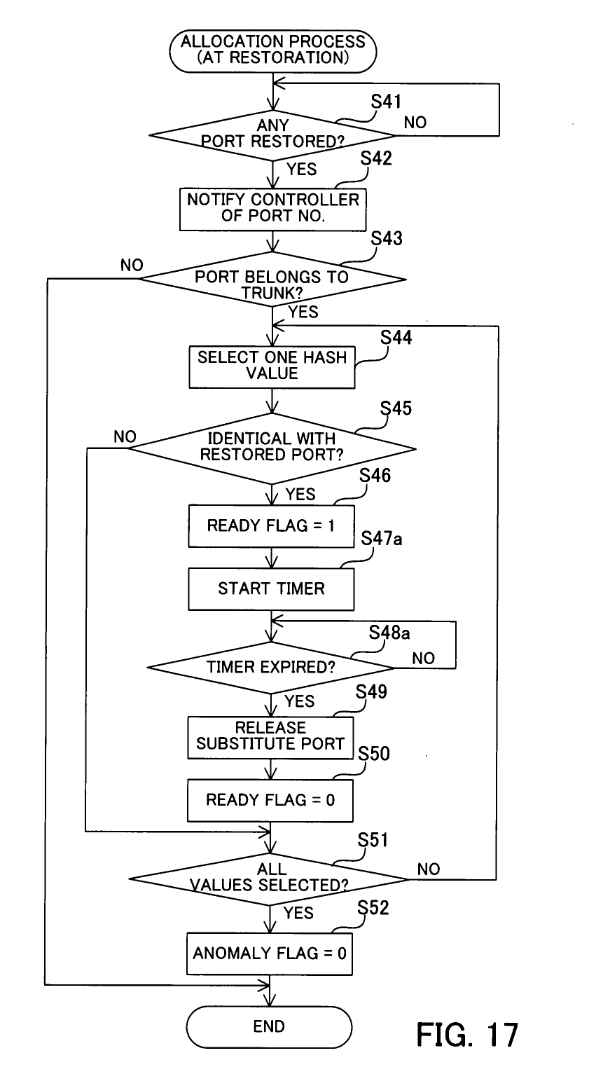

FIG. 17 is a flowchart illustrating another port allocation process executed at the time of restoration in the first embodiment. The flowchart of FIG. 17 is identical with that of FIG. 16 except that Steps S47 and S48 are respectively replaced by Steps S47a and S48a explained below.

Step S47a: The setting controller 130 starts a timer. The timer is adapted to measure a time period set in advance based on a maximum delay time that is required until a frame stored in the FIFO queue of the output queue 170 is output to the communication port.

Step S48a: The setting controller 130 determines whether or not the timer started in Step S47a has expired. If the timer has expired, the process proceeds to Step S49; if not, Step S48a is repeatedly executed until the timer expires.

With the method using the timer, the same advantage as that achieved with the marker request can be obtained even in the case where destination communication devices are not designed to handle the marker request.

Thus, in the communication device of the first embodiment, failure of a physical link affects only those frames which are allocated to the faulty physical link and does not affect frames allocated to the other physical links. Accordingly, where a physical link fails, frames need not be discarded in order to prevent the reversal of the transfer order of frames. Also, even in cases where two or more physical links fail, the aforementioned processes permit the trunk to be continuously operated with the use of the remaining normal physical links.

Moreover, when the faulty physical link is restored to normalcy, only the frames allocated to the substitute physical link have to be temporarily discarded, and it is unnecessary to discard the other frames.

Further, since multiple hash values are correlated with one physical link, multiple substitutes can be prepared for a faulty physical link, making it possible to prevent the substitutes from concentrating at a certain physical link.

In the updated port allocation table 143 shown in FIG. 14, the allocation ratios of the communication ports P14, P15 and P16 are 3/8, 3/8, and 2/8, respectively. Namely, the difference in the allocation ratio is 1/8 at a maximum. In the case of the aforementioned method, the difference in the allocation ratio between the communication ports can be made smaller by using a greater number of hash values.

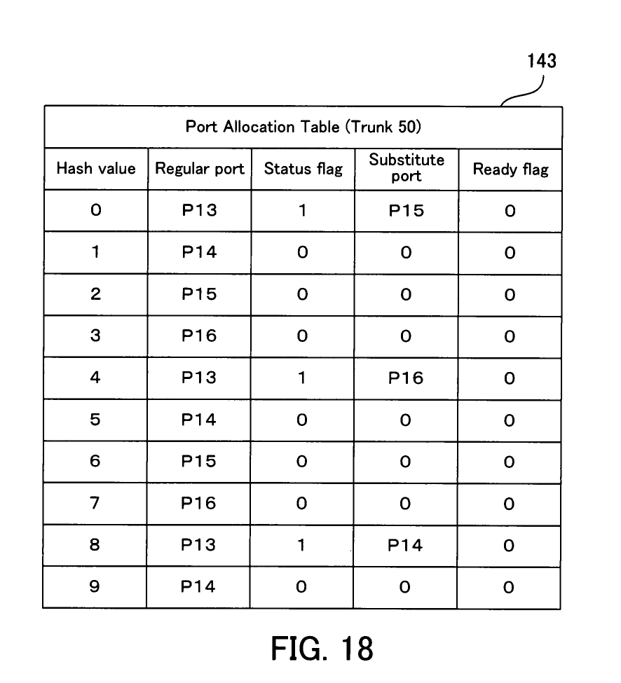

FIG. 18 shows another exemplary data structure of the port allocation table according to the first embodiment. The port allocation table 143 shown in FIG. 18 differs from the counterpart shown in FIG. 14 in that the number of hash values is ten (“0” to “9”). In the example shown in FIG. 18, the allocation ratios of the communication ports P14, P15 and P16 are 4/10, 3/10, and 3/10, respectively. Namely, the difference in the allocation ratio is 1/10 at a maximum.

Thus, by adjusting the number of hash values to be used, it is possible to flexibly set the allocation ratios. Also, the number of hash values can be variably set with respect to each trunk.

### Second Embodiment

A second embodiment of the present invention will be now described in detail with reference to the drawings. The following explanation is focused on the differences between the first and second embodiments and description of identical elements and the like is omitted. The second embodiment differs from the first embodiment in that the substitute ports are set in a different manner.

The system configuration of the second embodiment is identical with that of the first embodiment shown in FIGS. 2 and 3. Also, the configuration of the switch of the second embodiment is in principle identical with that of the switch of the first embodiment shown in FIG. 4. In the second embodiment, however, a setting controller 130a, a table memory 140a and a switch section 160a having functions explained below are used in place of the setting controller 130, the table memory 140, and the switch section 160. The functions of the other elements are identical with those of the counterparts of the first embodiment.

Like the first embodiment, the table memory 140a stores the trunk number table 141 shown in FIG. 6, and the switch section 160a has the learning table 161 shown in FIG. 7. In the second embodiment, the table memory 140a stores a port allocation table 144 described below, in place of the trunk configuration control table 142 and the port allocation table 143 shown in FIGS. 8 and 9.

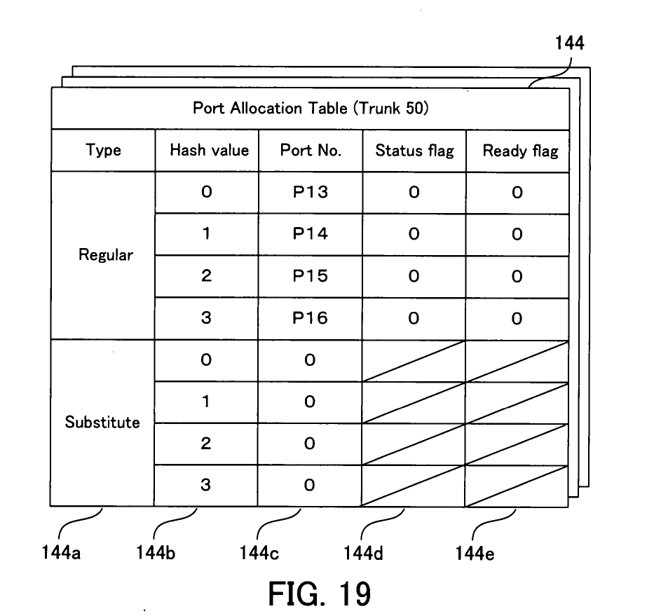

FIG. 19 shows an exemplary data structure of the port allocation table of the second embodiment. The port allocation table 144 is stored in the table memory 140a in the manner associated with each trunk and defines the correlation between MAC addresses and communication ports for outputting frames.

The port allocation table 144 has fields 144a showing types, fields 144b showing hash values, fields 144c showing port numbers, fields 144d showing the states of a status flag, and fields 144e showing the states of a ready flag. A set of information items contained in each horizontal row of fields are associated with one another.

Values “Regular” and “Substitute” are set in the fields 144a, dividing the port allocation table 144 into two regions. The “Regular” region shows the correlation between hash values and regular communication ports, and the “Substitute” region shows the correlation between hash values and substitute communication ports.

A hash value calculated from the MAC address of a frame is set in the field 144b. Hash values equal in number to the communication ports belonging to the trunk are set in each of the “Regular” and “Substitute” regions. Namely, the communication ports and the hash values are correlated in one-to-one correspondence. The field 144c holds the port number of a communication port. However, the initial value “0” is set in the “Substitute” region.

The field 144d holds a value indicating the status of the communication port specified in the corresponding field 144c. Specifically, “0” is set if the physical link connected to the communication port is normal, and “1” is set if the physical link is faulty. The field 144e is used when the physical link recovers from fault, and holds a flag indicating a preparatory time upon expiry of which the use of the restored physical link is restarted. Specifically, “0” is set if the current time is not within the preparatory time, and “1” is set if the current time is within the preparatory time. No values are set in the fields 144d and 144e of the “Substitute” region.

The information in the port allocation table 144 is registered beforehand by the setting controller 130a in response to the input operation by the administrator. The values set in the fields 144c of the “Substitute” region and the values set in the fields 144d and 144e are updated by the setting controller 130a when necessary.

Processes executed by the system configured as described above will be now described in detail. Where all of the physical links constituting the trunk 50 are normal, the frame transfer process is carried out in the same manner as that of the first embodiment shown in FIG. 10. In the following, explanation will be made of (1) the manner of how the frame allocation method is changed when one of the physical links in the trunk 50 fails, (2) the frame transfer process executed after the allocation method is changed, and (3) the manner of how the allocation method is changed again when the faulty physical link is restored to normalcy, in the order mentioned.

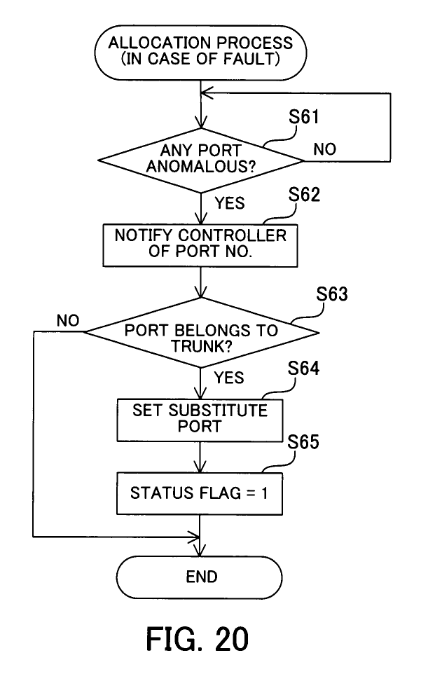

FIG. 20 is a flowchart illustrating a port allocation process executed in case of fault according to the second embodiment. The process shown in FIG. 20 will be explained below in order of step number.

Step S61: The port monitor 190, which continuously monitors the status of the communication ports, determines whether or not there is an anomalous communication port. If there is an anomalous communication port, the process proceeds to Step S62; if there is no anomalous communication port, Step S61 is repeatedly executed by the port monitor 190.

Step S62: The port monitor 190 notifies the setting controller 130a of the port number of the communication port with respect to which anomaly was detected in Step S61.

Step S63: The setting controller 130a searches the trunk number table 141 stored in the table memory 140a, to determine whether the communication port with the port number notified from the port monitor 190 belongs to a trunk or not. If the communication port belongs to a trunk, the process proceeds to Step S64; if not, the allocation process ends.

Step S64: The setting controller 130a identifies the trunk number from the trunk number table 141, and selects the port allocation table 144 corresponding to the identified trunk number. Then, the setting controller 130a identifies normal communication ports and sets the port numbers of the normal communication ports in the “Substitute” region of the port allocation table 144. The port numbers are set in the “Substitute” region in ascending order of the hash value.

Step S65: The setting controller 130a sets “1” for the status flag corresponding to the port number notified in Step S62.

Thus, on detecting a faulty communication port, the port monitor 190 notifies the setting controller 130a of the port number of the detected communication port. The setting controller 130a then manipulates the port allocation table 144 to correlate the remaining normal communication ports with the hash values.

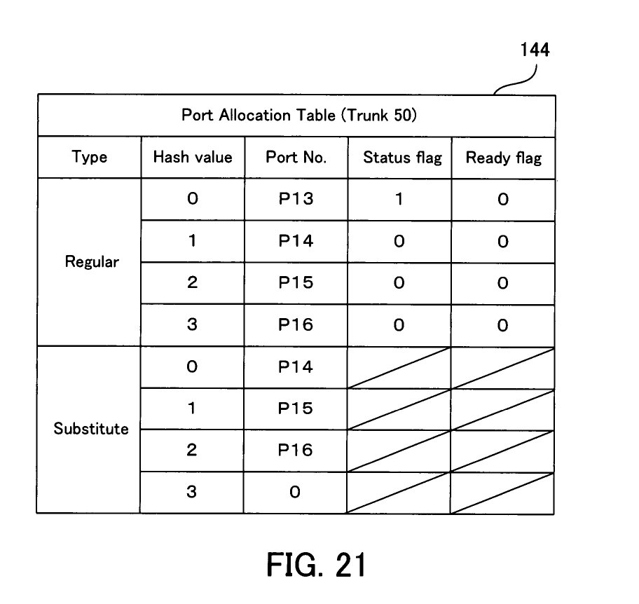

FIG. 21 shows an example of updating of the port allocation table of the second embodiment, wherein the port allocation table 144 has been updated by the setting controller 130a as a result of the occurrence of a fault in the physical link connected to the communication port P13. As shown in FIG. 21, the correlation between the normal communication ports P14, P15 and P16 and the hash values has been set in the “Substitute” region as a result of the execution of the aforementioned Step S64. Also, the status flag associated with the anomalous communication port P13 has been set to “1”.

The following describes the frame transfer process executed after the allocation method is changed. The frame transfer process executed when there is a faulty physical link in the trunk is in principle identical with that shown in FIG. 10, as in the first embodiment. When determining the output communication port in Step S20, however, the use of the substitute port in lieu of the regular port needs to be taken into account.

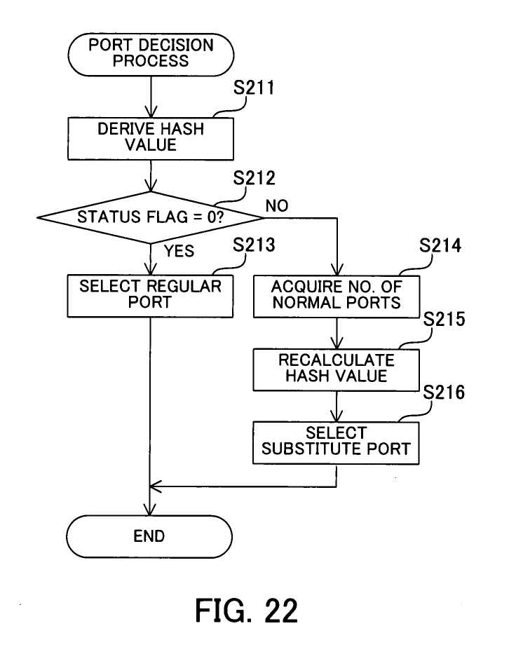

FIG. 22 is a flowchart illustrating a transfer port decision process according to the second embodiment. The flowchart of FIG. 22 shows details of Step S20 in FIG. 10. The process shown in FIG. 22 will be explained below in order of step number.

Step S211: The switch section 160a calculates a hash value for the acquired frame. Specifically, an exclusive-OR of the destination and source MAC addresses of the frame is derived as a dividend, and the dividend is divided by a divisor equal to the number of communication ports set in the “Regular” region of the port allocation table 144, to obtain the remainder.

Step S212: The switch section 160a searches the “Regular” region of the port allocation table 144 to determine whether the status flag associated with the hash value calculated in Step S211 is “0” or not. If the status flag is “0”, the process proceeds to Step S213; if the status flag is “1”, the process proceeds to Step S214.

Step S213: The switch section 160a determines the regular communication port corresponding to the hash value calculated in Step S211, as the target to which the frame is to be output.

Step S214: The switch section 160a acquires the number of communication ports set in the “Substitute” region of the port allocation table 144.

Step S215: The switch section 160a again calculates a hash value for the acquired frame. Specifically, the dividend, which is the exclusive-OR of the destination and source MAC addresses of the frame, is divided by a divisor equal to the number of communication ports acquired in Step S214, to obtain the remainder.

Step S216: The switch section 160a determines the substitute communication port corresponding to the hash value calculated in Step S215, as the target to which the frame is to be output.

In this manner, the switch section 160a reallocates only the communication port associated with a faulty physical link to the substitute port and does not reallocate the communication ports associated with normal physical links. Also, different divisors are used to calculate the first and second hash values, and accordingly, frames allocated to the faulty physical link are reallocated to multiple substitute physical links.

The following describes how the allocation method is changed again when the faulty physical link is restored to normalcy.

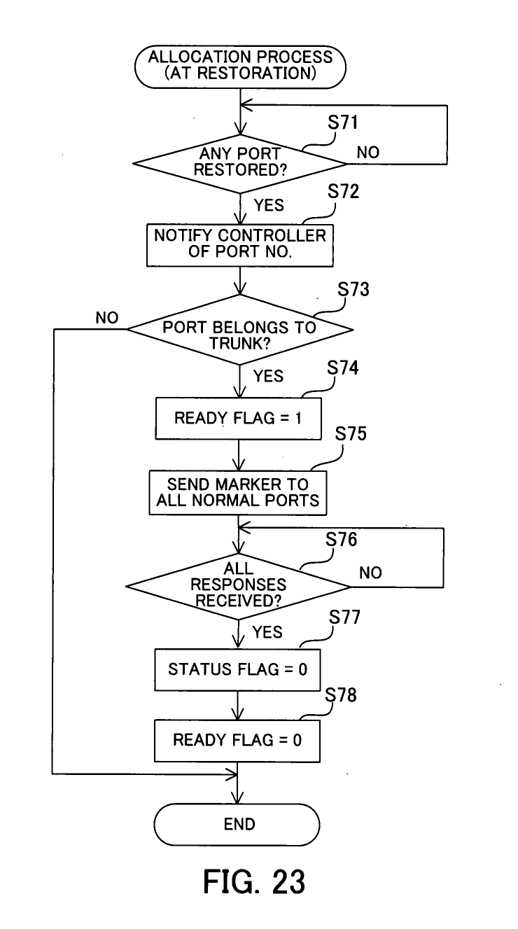

FIG. 23 is a flowchart illustrating a port allocation process executed at the time of restoration in the second embodiment. The process shown in FIG. 23 will be explained below in order of step number.

Step S71: The port monitor 190, which continuously monitors the status of the communication ports, determines whether or not there is a physical link that has been restored to normalcy. If there is a restored physical link, the process proceeds to Step S72; if there is no restored physical link, Step S71 is repeatedly executed by the port monitor 190.

Step S72: The port monitor 190 notifies the setting controller 130a of the port number of the communication port with respect to which the restoration was detected.

Step S73: The setting controller 130a searches the trunk number table 141 stored in the table memory 140a, to determine whether the communication port with the port number notified from the port monitor 190 belongs to a trunk or not. If the communication port belongs to a trunk, the process proceeds to Step S74; if not, the allocation process ends.

Step S74: The setting controller 130a selects the port allocation table 144 corresponding to the trunk identified in Step S73. Then, the setting controller 130a sets the ready flag associated with the port number notified in Step S72 to “1”.

Step S75: The setting controller 130a instructs the marker inserter 185 to output a marker request to all of the normal communication ports. On receiving the instruction, the marker inserter 185 creates marker requests and sends the requests to the output queue 170 while specifying the port numbers instructed from the setting controller 130a.

Step S76: The setting controller 130a determines whether or not the marker processor 180 has received marker responses responsive to all marker requests sent in Step S75. If all responses have been received, the process proceeds to Step S77; if not, Step S76 is repeatedly executed until all responses are received.

Step S77: The setting controller 130a resets the status flag associated with the port number notified in Step S72 to “0”.

Step S78: The setting controller 130a resets the ready flag associated with the port number notified in Step S72 to “0”.

Thus, on detecting the restoration of a physical link to normalcy, the port monitor 190 notifies the setting controller 130a of the port number of the communication port connected to the restored physical link. The setting controller 130a then manipulates the port allocation table 144 to cancel the substitute communication port setting with respect to the notified communication port.

While the ready flag remains at “1”, the switch section 160a stops outputting frames to the substitute communication port and discards the frames. Specifically, whether the ready flag is “1” or not is determined in Step S214 of the port decision process shown in FIG. 22, and if the ready flag is “1”, frames are discarded. It should be noted, however, that not all of the frames allocated to the trunk are discarded but only those frames with respect to which “1” is set as the ready flag are discarded.

In the example explained above, marker requests and marker responses are used to prevent the reversal of the transfer order of frames, but a timer may be used instead.

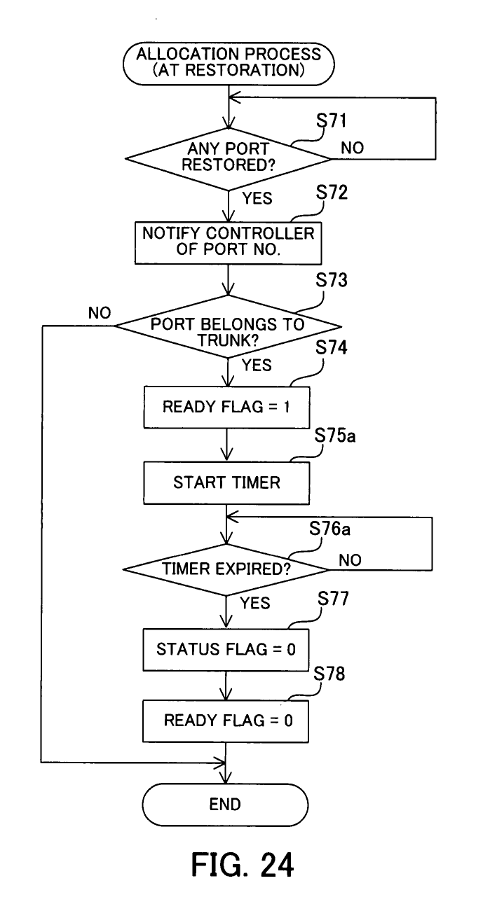

FIG. 24 is a flowchart illustrating another port allocation process executed at the time of restoration in the second embodiment. The flowchart of FIG. 24 is identical with that of FIG. 23 except that Steps S75 and S76 are respectively replaced by Steps S75a and S76a explained below.

Step S75a: The setting controller 130a starts a timer. The timer is adapted to measure a time period set in advance based on a maximum delay time that is required until a frame stored in the FIFO queue of the output queue 170 is output to the communication port.

Step S76a: The setting controller 130a determines whether or not the timer started in Step S75a has expired. If the timer has expired, the process proceeds to Step S77; if not, Step S76a is repeatedly executed until the timer expires.

With the method using the timer, the same advantage as that achieved with the marker request can be obtained even in the case where destination communication devices are not designed to handle the marker request.

Thus, in the communication device of the second embodiment, failure of a physical link affects only those frames which are allocated to the faulty physical link and does not affect frames allocated to the other physical links. Accordingly, where a physical link fails, frames need not be discarded in order to prevent the reversal of the transfer order of frames. Also, even in cases where two or more physical links fail, the aforementioned processes permit the trunk to be continuously operated with the use of the remaining normal physical links.

Moreover, when the faulty physical link is restored to normalcy, only the frames allocated to the substitute physical link have to be temporarily discarded, and it is unnecessary to discard the other frames.

Further, the first hash values are correlated with the physical links in one-to-one correspondence, and the second hash values are correlated with the normal physical links in one-to-one correspondence. This permits the frames allocated to a faulty physical link to be reallocated evenly among the other normal physical links, and also the memory area necessary to store the tables can be minimized.

### Third Embodiment

Although in the foregoing description of the first and second embodiments, the case where a physical link fails and then is restored to normalcy is explained, the aforementioned processing function can be applied to dynamic reallocation of the communication ports belonging to a trunk. In the following, a third embodiment will be explained wherein communication ports belonging to a trunk are dynamically reallocated by using the switch of the first embodiment. The process can also be performed using the switch of the second embodiment.

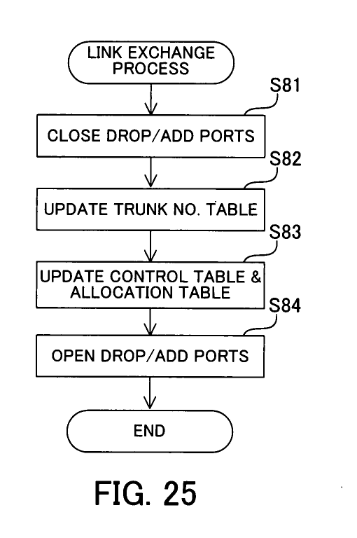

FIG. 25 is a flowchart illustrating a link exchange process. The administrator operates the terminal 40 to cause the setting controller 130 to execute the following process.

Step S81: In accordance with the administrator's instructions, the setting controller 130 closes the communication port to be dropped from the trunk and the communication port to be added to the trunk. Alternatively, the administrator may detach the physical links connected to the communication ports. As a result, anomaly of the communication ports is detected, and the operation is continued with frames automatically allocated to the remaining normal physical links.

Step S82: In accordance with the administrator's instructions, the setting controller 130 updates the trunk number table 141. Specifically, the trunk number is set with respect to the communication port to be added to the trunk, and also with respect to the communication port to be dropped from the trunk, the trunk number is set to “0”.

Step S83: In accordance with the administrator's instructions, the setting controller 130 updates the trunk configuration control table 142 and the port allocation table 143. Specifically, the port number of the communication port to be dropped from the trunk is replaced with the port number of the communication port to be added to the trunk.

Step S84: In accordance with the administrator's instructions, the setting controller 130 opens the communication port to be dropped from the trunk and the communication port to be added to the trunk. Alternatively, the administrator attaches the detached physical links to the communication ports. Consequently, restoration of the communication ports is detected, and frames previously allocated to the dropped physical link are automatically reallocated to the added physical link.

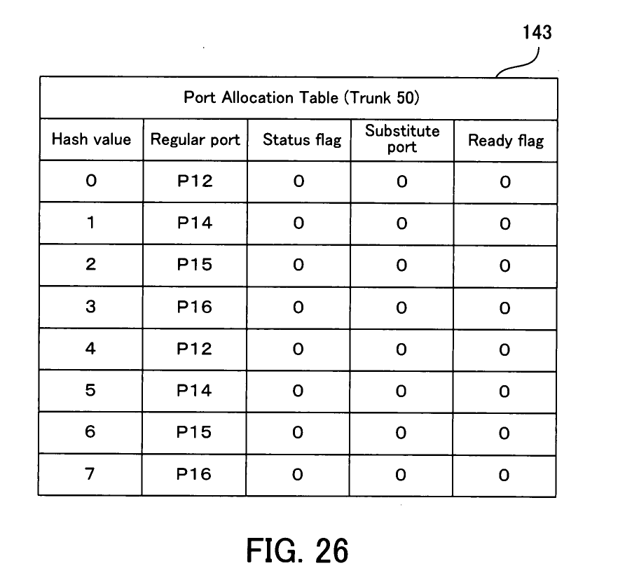

FIG. 26 shows an example of updating of the port allocation table as a result of such link exchange. As shown in FIG. 26, the port allocation table 143 of the first embodiment has been updated by the aforementioned process such that the communication port P13 is replaced with the communication port P12.

Thus, by using the communication device of the third embodiment, it is possible to minimize the number of discarded frames also in the case of dynamically exchanging communication ports belonging to a trunk.

In the above description of the embodiments, a Layer 2 switch is used as the communication device, but other types of communication device with the frame transfer function may also be used. For example, a router capable of performing process at a higher level than the Data-link layer may be used. In this case, the process for the higher layer than the Data-link layer is additionally executed after a frame is received and before the frame is output to the FIFO queue.

While the communication device and method of the present invention have been described with reference to the embodiments illustrated in the drawings, it is to be noted that the invention is not limited to these embodiments and the individual constituent elements may be replaced with desired ones having similar functions. Also, other desired constituent elements or processes may be added to the present invention. Further, two or more optional constituent elements (features) of the foregoing embodiments may be combined.

According to the present invention, when a fault of a physical link constituting a logical link is detected, the range of addresses allocated to the faulty physical link is divided into multiple sections to be reallocated among the remaining normal physical links. Accordingly, only the addresses allocated to the faulty physical link are reallocated to the other physical links while the addresses allocated to the normal physical links are not reallocated, permitting the transfer of frames to be continued. This serves to restrain the temporary discard of frames, which is required in the conventional devices in order to maintain the arrival order of frames, thus making it possible to realize a stabler communication path with higher quality.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication device for transferring frames by using a logical link constituted by an aggregation of physical links, comprising:
table memory means storing an allocation table showing a correlation between addresses included in incoming frames and the physical links via which the incoming frames are to be output;
setting controller means, responsive to detection of a fault in any of the physical links, for manipulating the allocation table to divide a range of the addresses allocated to the faulty physical link into multiple sections to be reallocated among normal ones of the physical links; and
switch means, responsive to reception of a frame, for looking up the allocation table and determining, in accordance with the address included in the received frame, which of the normal physical links is to be used to output the received frame.

2. The communication device according to claim 1, wherein the allocation table holds, as the correlation, one-to-many correspondence between the physical links and hash values calculated from the addresses by using a hash function that can assume a number greater than the number of the physical links constituting the logical link,
the setting controller means causes the multiple hash values associated with the faulty physical link to be reallocated among the multiple normal physical links, and
the switch means calculates the hash value from the address of the received frame by using the hash function, to determine which of the physical links is to be used to output the received frame.

3. The communication device according to claim 1, wherein the allocation table holds, as the correlation, a correlation between the physical links and first hash values calculated from the addresses, and a correlation between the normal physical links and second hash values calculated from the addresses by a method different from that used to calculate the first hash values,
the setting controller means updates the correlation between the normal physical links and the second hash values upon detection of the faulty physical link, and
the switch means calculates the first hash value from the address of the received frame and, only if the physical link corresponding to the calculated first hash value is faulty, calculates the second hash value from the address, to determine which of the physical links is to be used to output the received frame.

4. The communication device according to claim 1, wherein, on detection of restoration of the faulty physical link to normalcy, the setting controller means cancels the reallocation of the address range to the normal physical links, and forbids use of the restored physical link until it is ascertained that a last reallocated frame output before the cancellation of the reallocation has reached the other end of the logical link, and
the switch means discards received frames with the addresses allocated to the restored physical link while the use of the restored physical link is forbidden.

5. The communication device according to claim 4, wherein, upon lapse of a predetermined time from the cancellation of the reallocation, the setting controller means judges that the last reallocated frame output before the cancellation of the reallocation has reached the other end of the logical link.

6. The communication device according to claim 4, wherein, when the reallocation is to be canceled, the setting controller means sends a marker frame to the reallocated physical link, and when a response to the marker frame is received from the other end of the logical link, the setting controller means judges that the last reallocated frame output before the cancellation of the reallocation has reached the other end of the logical link.

7. A communication method for transferring frames by using a logical link constituted by an aggregation of physical links, comprising the steps of:
on detection of a fault in any of the physical links, manipulating an allocation table showing a correlation between addresses included in incoming frames and the physical links via which the incoming frames are to be output, to divide a range of the addresses allocated to the faulty physical link into multiple sections to be reallocated among normal ones of the physical links; and
on reception of a frame, looking up the allocation table and determining, in accordance with the address included in the received frame, which of the normal physical links is to be used to output the received frame.

8. A communication device for transferring frames by using a logical link constituted by an aggregation of physical links, comprising:
a table memory storing an allocation table showing a correlation between addresses included in incoming frames and the physical links via which the incoming frames are to be output;
a setting controller, responsive to detection of a fault in any of the physical links, for manipulating the allocation table to divide a range of the addresses allocated to the faulty physical link into multiple sections to be reallocated among normal ones of the physical links; and
a switch, responsive to reception of a frame, for looking up the allocation table and determining, in accordance with the address included in the received frame, which of the normal physical links is to be used to output the received frame.
